(19) United States
(12) Patent Application Publication
(10) Pub. No.: US 2018/0144740 A1
(43) Pub. Date: May 24, 2018

(54) METHODS AND SYSTEMS FOR LOCATING THE END OF THE KEYWORD IN VOICE SENSING

(71) Applicant: Knowles Electronics, LLC, Itasca, IL (US)

(72) Inventors: Jean Laroche, Itasca, IL (US); Sridhar Nemala, Itasca, IL (US); Sundararajan Srinivasan, Itasca, IL (US); Hitesh Gupta, Itasca, IL (US)

(73) Assignee: Knowles Electronics, LLC, Itasca, IL (US)

(21) Appl. No.: 15/808,213

(22) Filed: Nov. 9, 2017

Related U.S. Application Data
(60) Provisional application No. 62/425,155, filed on Nov. 22, 2016.

(51) Int. Cl. G10L 15/05; G10L 15/08; G10L 15/22

(52) U.S. Cl. CPC G10L 15/05; G10L 15/08; G10L 15/142; G10L 2015/088; G10L 15/22

(57) ABSTRACT

Systems and methods for locating the end of a keyword in voice sensing are provided. An example method includes receiving an acoustic signal that includes a keyword portion immediately followed by a query portion. The acoustic signal represents at least one captured sound. The method further includes determining the end of the keyword portion. The method further includes, separating, using the end of the keyword portion, the query portion from the keyword portion of the acoustic signal. The method further includes providing the query portion, absent any part of the keyword portion, to an automatic speech recognition (ASR) system.

### CROSS-REFERENCE TO RELATED APPLICATIONS

This application claims the benefit of and priority to U.S. Provisional Application No. 62/425,155, filed Nov. 22, 2016, the entire contents of which are incorporated herein by reference.

### BACKGROUND

There are voice wakeup systems designed to allow a user to perform a voice search by uttering a query immediately after uttering a keyword. A typical example of a voice search (assuming the keyword is “Hello VoiceQ” and the query is “find the nearest gas station”), would be “Hello VoiceQ, find the nearest gas station.” Typically, the entire voice search utterance, including both the keyword and the query, are sent to an automatic speech recognition (ASR) engine for further processing. This can result in the ASR engine not properly recognizing the query. This failure can be due to the ASR engine confusing the keyword and query, e.g., mistakenly considering part of the keyword to be part of the query or mistakenly considering part of the query to be part of the keyword. As a result, the voice search may not be performed as the user intended.

Better voice search results could be obtained if just the whole query were sent to the ASR engine. It is, therefore, desirable to accurately and reliably separate the end of the keyword from the start of the query, and then send just the query to the ASR engine for further processing.

### BRIEF DESCRIPTION OF DRAWINGS

FIG. 1 is a block diagram illustrating a smart microphone environment, where methods for locating the end of a keyword can be practiced, according to various example embodiments.

FIG. 2 is a block diagram illustrating a smart microphone which can be used to practice the methods for locating the end of a keyword, according to various example embodiments.

FIG. 3 is a plot of an acoustic signal representing a captured user phrase, according to an example embodiment.

FIG. 4 is a plot of a confidence value of detection a keyword in a captured user phrase, according to an example embodiment.

FIG. 5 is a flow chart illustrating a method for locating the end of a keyword, according to an example embodiment.

FIG. 6 is a flow chart illustrating a method for locating the end of a keyword, according to another example embodiment.

### DETAILED DESCRIPTION

The technology disclosed herein relates to systems and methods for locating the end of a keyword in acoustic signals. Various embodiments of the disclosure can provide methods and systems for facilitating more accurate and reliable voice search based on an audio input including a voice search query uttered after a keyword. The keyword can be designed to trigger a wakeup of a voice sensing system (e.g., “Hello Voice Q), whereas the query (e.g., find the nearest gas station”) includes information upon which a search can be performed.

Various embodiments of the disclosure can facilitate more accurate voice searches by providing a clean query to the automatic speech recognition (ASR) engine for further processing. The clean query can include the entire query and only the entire query, absent any part of the keyword. This approach can assist the ASR engine by determining the end of the keyword and separating out the query so that the ASR engine can more quickly and more reliably respond to just the question posed in the query.

Various embodiments of the present disclosure may be practiced with any audio device operable to capture and process acoustic signals. In various embodiments, audio devices can include smart microphones which combine microphone(s) and other sensors into a single device. Various embodiments may be practiced in smart microphones that include voice activity detection for providing a wakeup feature. Low power applications can be enabled by allowing the voice wakeup to provide a lower power mode in the smart microphone until a voice activity is detected.

In some embodiments, the audio devices may include hand-held devices, such as wired and/or wireless remote controls, notebook computers, tablet computers, phablets, smart phones, smart watches, media players, mobile telephones, and the like. In certain embodiments, the audio devices may include a personal desktop computer, TV sets, car control and audio systems, smart thermostats, and so forth. The audio devices may have radio frequency (RF) receivers, transmitters, and transceivers, wired and/or wireless telecommunications and/or networking devices, amplifiers, audio and/or video players, encoders, decoders, loud speakers, inputs, outputs, storage devices, and user input devices.

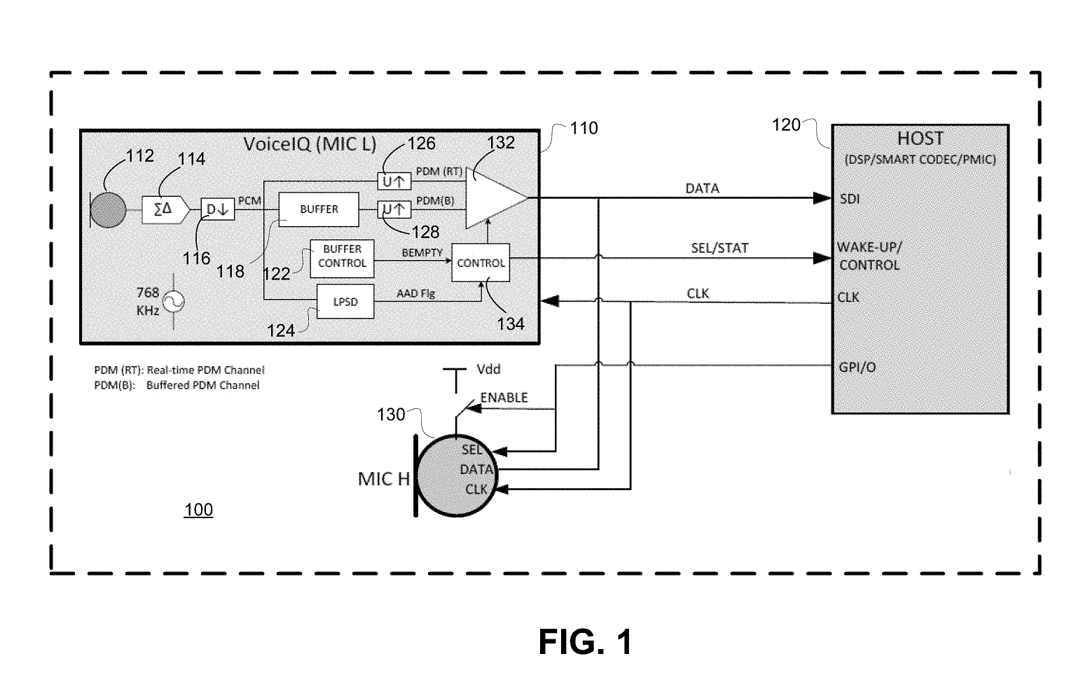

Referring now to FIG. 1, an example smart microphone environment 100 is shown in which methods for locating the end of a keyword can be practiced, according to various embodiments of the present disclosure. The example smart microphone environment 100 can include a smart microphone 110 which communicates with a host device 120. In some embodiments, the host device 120 may be integrated with the smart microphone 110 into a single device, as shown by the dashed lines in FIG. 1. In certain embodiments, the smart microphone environment 100 includes at least one additional microphone 130.

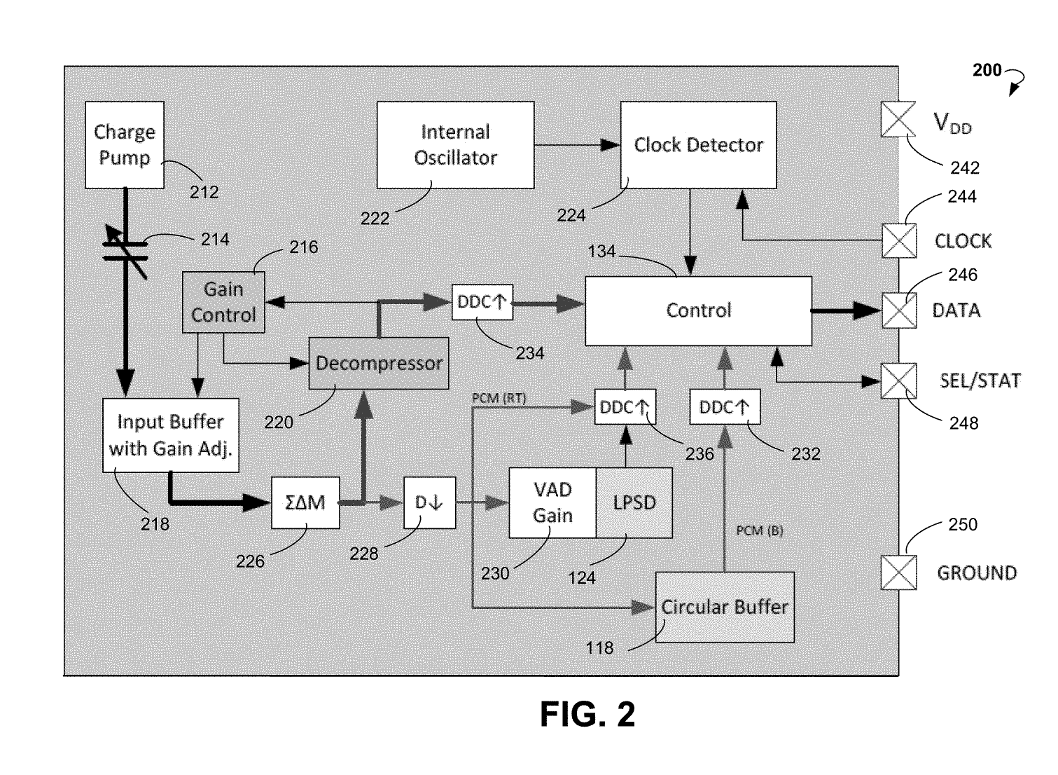

In some embodiments, the smart microphone 110 includes an acoustic sensor 112, a sigma-delta modulator 114, a downsampling element 116, a circular buffer 118, upsampling elements 126 and 128, amplifier 132, a buffer control element 122, a control element 134, and a low power sound detect (LPSD) module 124. The acoustic sensing device 112 may include, for example, a microelectromechanical system (MEMS), a piezoelectric sensor, and so forth. In various embodiments, components of the smart microphone 110 are implemented as combinations of hardware and programmed software. At least some of the components of the smart microphone 110 may be disposed on an application-specific integrated circuit (ASIC). Further details concerning various elements in FIG. 1 are described below with respect to an example embodiment of the smart microphone in FIG. 2

In various embodiments, the smart microphone 110 may operate in multiple operational modes, including a voice activity detection (VAD) mode, a signal transmit mode, and a burst mode. While operating in the voice activity detection mode, the smart microphone 110 may consume less power than in the signal transmit mode.

While in the VAD mode, the smart microphone 110 may detect voice activity. Upon detection of the voice activity, the select/status (SEL/STAT) signal may be sent from the smart microphone 110 to the host device 120 to indicate the presence of the voice activity detected by the smart microphone 110.

In some embodiments, the host device 120 includes various processing elements, such as a digital signal processing (DSP) element, a smart codec, a power management integrated circuit (PMIC), and so forth. The host device 120 may be part of a device, such as, but not limited to, a cellular phone, a smart phone, a personal computer, a tablet, and so forth. In some embodiments, the host device is communicatively connected to a cloud-based computational resource (also referred to as a computing cloud).

In response to receiving an indication of the presence of a voice activity, the host device 120 may start a wakeup process. After the wakeup latency period, the host device 120 may provide the smart microphone 110 with a clock (CLK) (for example, 768 kHz). Responsive to receipt of the external CLK clock signal, the smart microphone 110 can enter a signal transmit mode.

In the signal transmit mode, the smart microphone 110 may provide buffered audio data (DATA signal) to the host 120 at the serial digital interface (SDI) input. In some embodiments, the buffered audio data may continue to be provided to the host device 120 as long as the host device 120 provides the external clock signal CLK to the smart microphone 110.

In some embodiments, a burst mode can be employed by the smart microphone 110 in order to reduce the latency due to the buffering of the audio data. The burst mode can provide faster than real time transfer of data between the smart microphone 110 and the host device 120. Example methods employing a burst mode are provided in U.S. patent application Ser. No. 14/989,445, filed Jan. 6, 2016, entitled “Utilizing Digital Microphones for Low Power Keyword Detection and Noise Suppression”, which is incorporated herein by reference in its entirety.

FIG. 2 is a block diagram showing an example smart microphone 200, according to another example embodiment of the disclosure. In various embodiments, the example smart microphone 200 is an embodiment of the smart microphone 110 in FIG. 1. The example smart microphone 200 may include a charge pump 212, a MEMS sensor 214, an input buffer (with gain adjust) 218, a sigma-delta modulator 226, a gain control element 216, a decompressor 220, a down sampling element 228, digital-to-digital converters 232, 234, and 236, a low power sound detect (LPSD) element 124 with a VAD gain element 230, a circular buffer 118, an internal oscillator 222, a clock detector 224, and a control element 134. The smart microphone 200 may include a voltage drain drain (VDD) pin 242, a CLOCK pin 244, a DATA pin 246, SEL/STAT pin 248, and a ground pin 250.

The charge pump 212 can provide voltage to charge up a diaphragm of the MEMS sensor 214. An acoustic signal including voice may move the diaphragm, thereby causing the capacitance of the MEMS sensor 214 to change from creating voltage to generating an analog electrical signal.

The clock detector 224 can control which clock is provided to the sigma-delta modulator 226. If an external clock is provided (at the CLOCK pin 244), the clock detector 224 can use the external clock. In some embodiments, if no external clock is provided, the clock detector 224 uses the internal oscillator 222 for data timing/clocking.

The sigma-delta modulator 226 may convert the analog electrical signal into a digital signal. The output of the sigma-delta modulator (representing a one-bit serial steam) can be provided to the LPSD element for further processing. In some embodiments, the further processing includes voice activity detection. In certain embodiments, the further processing includes also include keyword detection, for example, after detecting voice activity, determining that a specific keyword is present in the acoustic signal.

In some embodiments, the smart microphone 200 may detect voice activity while operating in an ultra-low power mode and running only on an internal clock without need for an external clock. In some embodiments, LPSD element 124 with VAD gain element 230 and a circular buffer 134 are configured to run at ultra-low power mode to provide VAD capabilities.

LPSD element 124 can be operable to detect voice activity in the ultra-low power mode. Sensitivity of the LPSD element 124 may be controlled via the VAD gain element 230 which provides an input to the LPSD module 124. The LPSD element 124 can be operable to monitor incoming acoustic signals and determine the presence of a voice-like signature indicative of voice activity.

Upon detection of an acoustic activity that meets trigger requirements to quality as voice activity detection, the smart microphone 200 can provide a signal to the SEL/STAT pin 248 to wake up a host device coupled to the smart microphone 200

In some embodiments, the circular buffer 118 stores acoustic data generated prior to detection of voice activity. In some embodiments, the circular buffer 118 may store 256 milliseconds of acoustic data. The host device can provides a CLK signal to a smart microphone CLK pin. Once the CLK signal is detected, the smart microphone 200 may provide data to the DATA pin.

In some embodiments, keyword detection can be performed within the smart microphone 110 (in FIG. 1) or within the smart microphone 200 (in FIG. 2) using, for example, the LPSD element with very limited DSP functionality (as compared to the DSP in the host device) for voice processing. In other embodiments, a separate DSP or application processor of the host device, after voice wakeup, can be used for various voice processing, including noise suppression and/or noise reduction and automatic speech recognition (ASR). In some embodiments, the example smart microphone environment including the smart microphone 200 may be communicatively connected to a cloud-based computational resource that can perform ASR.

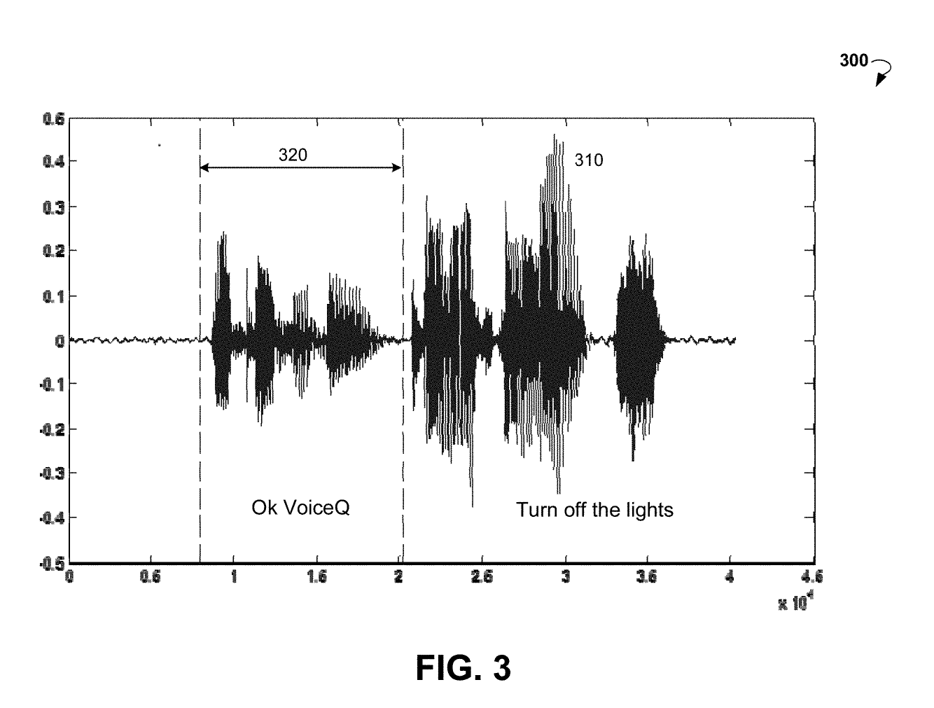

FIG. 3 is a plot 300 of example acoustic signal 310 representing a captured user speech that includes a keyword. In example of FIG. 3, the captured user speech includes keyword “Ok VoiceQ” and query “Turn off the lights.” As in example of FIG. 3, the “keyword” may be in the form of a phrase, also referred to as a key phrase. Part 320 of the signal 310 can represent keyword “Ok VoiceQ.” In some embodiments, the acoustic signal 310 is divided into frames. In certain embodiments, voice sensing determines a frame which corresponds to the end of the keyword. In some embodiments, the ASR is performed on the rest of acoustic signal 310 starting with a frame next to the frame corresponding to the end of the keyword. In some embodiments, the ASR can be performed on a host device using an application processor upon receipt of the acoustic signal from the smart microphone. In other embodiments, where the host device is communicatively coupled to a computing cloud, the ASR can be performed in the computing cloud. The host device may send the acoustic signal to the computing cloud, request performance of the ASR, and receive the results of the ASR, for example, as a text.

A determination as to which frame corresponds to the end of the keyword may be made based on a confidence value (i.e. posterior likelihood). The confidence value can represent a measurement of how well the part 320 of acoustic signal 310 matches a pre-determined keyword (for example, “Ok VoiceQ” in the example of FIG. 3). In some embodiments, the pre-determined keyword is selected from a list of keywords stored in a small vocabulary.

In some embodiments, the keyword detection is performed based on phoneme Hidden Markov model (HMM). In other embodiments, the keyword detection is performed using a neural network trained to output the confidence value. In these and other embodiments, the confidence value can be computed using Gaussian Mixture Models, or using Deep Neural Nets, or using any other type of detection scheme (e.g. support vector machines, etc.) In some embodiments, the confidence level can be calculated from the confidence values measured at a number of frames fed to the phoneme HMM or neural network. Therefore, the confidence level can be considered a function of a number of consecutive frames of the acoustic signal.

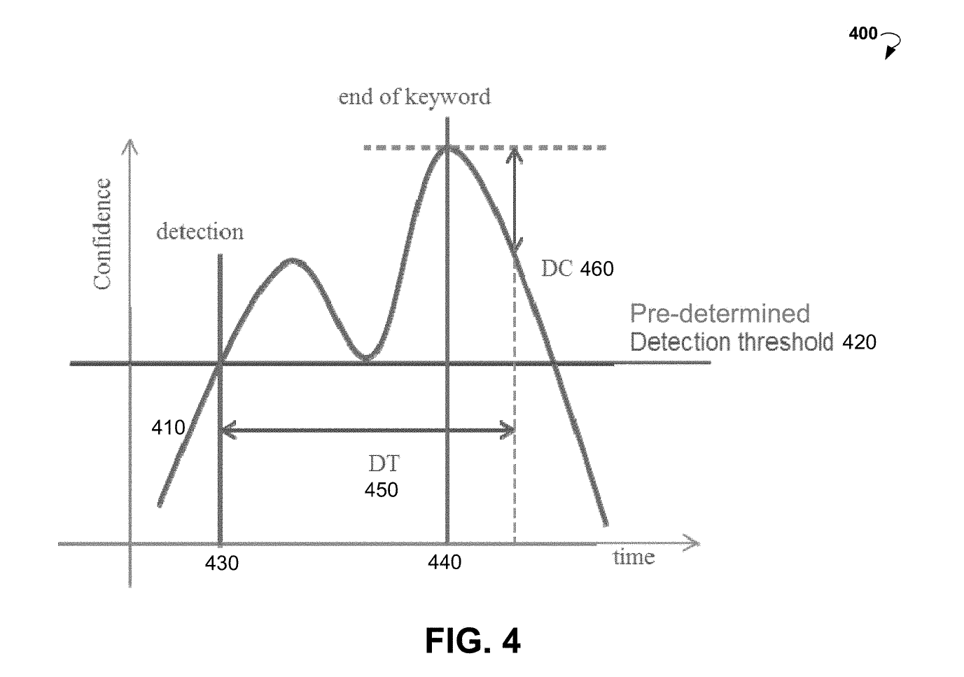

A plot 400 is an example plot of a confidence value 410 for an example signal is shown in FIG. 4. In a typical keyword detection method, a pre-determined detection threshold 420 can be provided. Typically, the part 320 in FIG. 3 can be considered to match the pre-determined keyword when the confidence value 410 reaches a pre-determined detection threshold 420. Thus, in a typical existing keyword detection method, the frame 430, at which the confidence value 410 reaches the pre-determined detection threshold 420, is marked as the end of the keyword in FIG. 4. However, the end-of-keyword frame in which the confidence value 410 reaches the pre-determined detection threshold 420 may not correspond to the real end of the keyword in the acoustic signal. As shown in the example in FIG. 4, the detection threshold 420 does not correspond to the actual end of the keyword.

Tests performed by the inventors have shown that the maximum of the confidence value correlates well with the true end of the keyword. In the tests, the standard deviation of the error between the true end of the keyword and the frame corresponding to the maximum of the confidence is less than 50 milliseconds, with the mean value at 0. In the example of FIG. 4, the frame at which the confidence crosses the detection threshold 420 does not correspond to the maximum of the confidence value 410.

According to various embodiments of the present disclosure, when a keyword detection occurs (due to the confidence value exceeding the detection threshold), the voice sensing flags a keyword detection event. In various embodiments, the voice sensing then continues to monitor the acoustic signal in frames to compute a running maximum of the confidence value for every frame. The frame (for example, frame 440 in FIG. 4) that corresponds to the maximum confidence value can be then flagged as the end-of-keyword frame.

In some embodiments, a fixed offset is added to the end-of-keyword frame. In these embodiments, the maximum value of the confidence may give a good estimate of the location of the end of the keyword, but for flexibility purposes an offset can be added when assigning the final end of keyword time. For example, some embodiments may mark the end of the keyword 10 ms later to prevent any part of the keyword in the query, and where it is not considered problematic if a very small amount of the query is accidentally removed. Other embodiments may mark the end of the keyword 10 ms earlier where it is important not to miss anything in the query.

The confidence value cannot be monitored forever for a hypothetical maximum value to occur. Therefore, in some embodiments, the monitoring is stopped when any of the following conditions are satisfied:

1) The time elapsed since the keyword detection exceeds a pre-determined duration time (DT) 450. In some embodiments, DT is between 100 or 200 milliseconds.

2) The confidence value at the current frame has dropped by a pre-determined threshold (marked as DC 460 in FIG. 4) relative to the running maximum of the confidence value.

3) The confidence value at the current frame has dropped below the detection threshold 420.

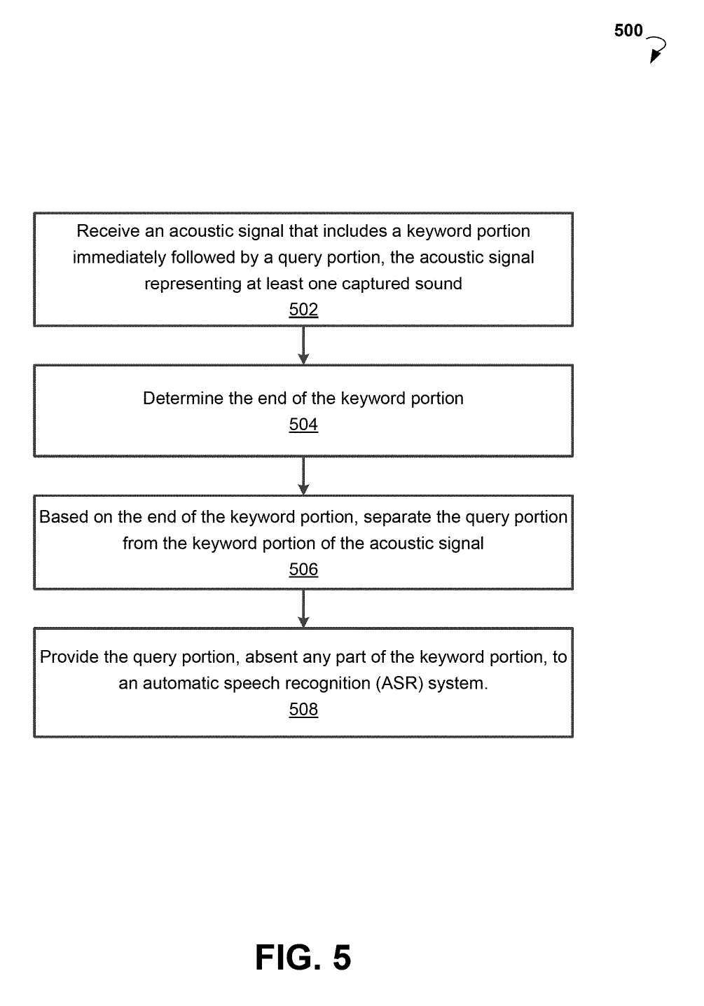

FIG. 5 is a flow chart showing steps of a method 500 for locating the end of a keyword, according to an example embodiment. For example, the method 500 can be implemented in environment 100 using smart microphone 110. In some embodiments, the method 500 is implemented using the smart microphone 110 for capturing an acoustic signal and using the host device 120 for processing the captured acoustic signal to locate the end of the keyword.

In some embodiments, method 500 commences in block 502 with receiving an acoustic signal that includes a keyword portion immediately followed by a query portion. The acoustic signal represents at least one captured sound. In block 504, method 500 can determine the end of the keyword portion. In block 506, method 500 can separate, based on the end of the keyword portion, the query portion from the keyword portion of the acoustic signal. In block 508, method 500 can provide the query portion, absent any part of the keyword portion, to an automatic speech recognition (ASR) system.

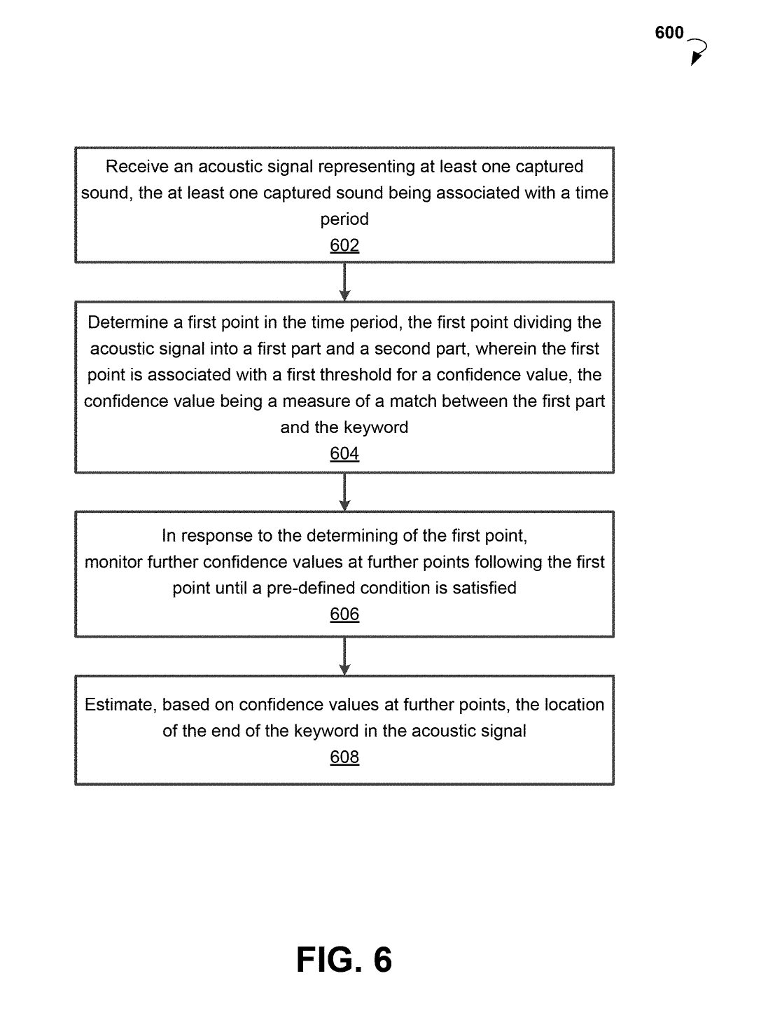

FIG. 6 is a flow chart showing steps of a method 600 for locating the end of a keyword, according to another example embodiment. The method 600 can be implemented in environment 100 using smart microphone 110. In some embodiments, the method 600 is implemented using the smart microphone 110 for capturing an acoustic signal and using the host device 120 for processing the captured acoustic signal to locate the end of the keyword. In some embodiments, method 600 commences in block 602 with receiving an acoustic signal. The acoustic signal can represent at least one captured sound and is associated with a time period.

In block 604, method 600 can determine a first point in the time period. The first point can divide the acoustic signal into a first part and a second part. The first point is a point at which a confidence level reaches a first threshold, where the confidence value represents a measure of degree of a match between the first part and the keyword (i.e., how well the first part of the acoustic signal matches the keyword.)

In response to the determination of the first point, method 600 can proceed, in block 606, to monitor further confidence values at further points following the first point. In some embodiments, during the monitoring, a running maximum of the confidence value is computed at every frame.

The monitoring can continue until determining that a predefined condition is satisfied. The predefined condition may include one of the following: further points reach a maximum predefined detection time, the further confidence values drops below the first threshold, and further confidence value drops below the maximum of the confidence values by a second pre-determined threshold.

In block 608, method 600 proceeds with estimating, based on the confidence values for the further points, the location of the end of the keyword. In some embodiments, the point that corresponds to the maximum value of the confidence values is assigned a location at the end of the keyword in the acoustic signal.

The present technology is described above with reference to example embodiments. Therefore, other variations upon the example embodiments are intended to be covered by the present disclosure.

What is claimed is:

1. A method for locating an end of a keyword, the method comprising:
receiving an acoustic signal that includes a keyword portion followed by a query portion, the acoustic signal representing at least one captured sound;
determining the end of the keyword portion;
based on the end of the keyword portion, separating the query portion from the keyword portion of the acoustic signal; and
providing the query portion, absent any part of the keyword portion, to an automatic speech recognition (ASR) system.

2. The method of claim 1, wherein the keyword portion includes one or more words, and wherein each of the words of the query portion, absent any part of the keyword portion, is provided to the ASR system.

3. The method of claim 1, wherein the acoustic signal is associated with a time period and wherein the determining of the end of the keyword portion includes:
determining a first point in the time period, the first point corresponding to a confidence value reaching a predetermined threshold, the confidence value being a measure of a degree of a match between the acoustic signal and a predefined keyword, the predefined keyword comprising one or more words;
in response to the confidence value reaching the predetermined threshold at the first point:
monitoring further confidence values at further points following the first point until a predefined condition is satisfied; and
estimating, based on the further confidence values, the location of the end of the keyword.

4. The method of claim 3, wherein the predefined condition is satisfied if a time elapsed after the first point exceeds a predetermined time duration.

5. The method of claim 3, wherein the predefined condition is satisfied if the confidence value drops below the predefined threshold.

6. The method of claim 3, further comprising shifting the estimated end of the keyword by a fixed offset.

7. The method of claim 3, further comprising, while monitoring, computing a running maximum of the confidence value.

8. The method of claim 7, wherein the estimating of the location of the end of the keyword includes determining a point in the time period corresponding to the maximum computed confidence value during the monitoring.

9. The method of claim 7, wherein the predefined condition is satisfied if the confidence value drops below the running maximum minus an offset.

10. A system for locating an end of a keyword, the system comprising:
an acoustic sensor; and
a digital processor, communicatively coupled to the acoustic sensor and configured to:
receive an acoustic signal that includes a keyword portion immediately followed by a query portion, the acoustic signal representing at least one sound captured by the acoustic sensor;
determine the end of the keyword portion;
based on the end of the keyword portion, separate the query portion from the keyword portion of the acoustic signal; and
provide the query portion, absent any part of the keyword portion, to an automatic speech recognition (ASR) system.

11. The system of claim 10, wherein the acoustic sensor and the digital processor are disposed on an application-specific integrated circuit.

12. The system of claim 10, wherein the acoustic sensor is disposed on a smart microphone and the digital processor is located in a host device external to the smart microphone.

13. The method of claim 10, wherein the keyword portion includes one or more words, and wherein each of the words of the query portion, absent any part of the keyword portion, is provided to the ASR system.

14. The system of claim 10, wherein the acoustic signal is associated with a time period and wherein for determining the end of the keyword portion the digital processor is configured to:
determine a first point, in the time period, at which a confidence value reaches a predetermined threshold, the confidence value being a measure of a degree of a match between the acoustic signal and a predefined keyword, the keyword comprising one or more words;
in response to the confidence value reaching the predetermined threshold at the first point:
monitor further confidence values at further points following the first point until a predefined condition is satisfied; and
estimate, based on the further confidence values, the location of the end of the keyword.

15. The system of claim 14, wherein the predefined condition is satisfied if a time elapsed after the first point exceeds a predetermined time duration.

16. The system of claim 14, wherein the predefined condition is satisfied if the confidence value drops below the predefined threshold.

17. The system of claim 14, wherein during the monitoring the digital processor is further configured to compute a running maximum of the confidence value.

18. The system of claim 17, wherein the location of the end of the keyword corresponds to the maximum computed confidence value during the monitoring.

19. The system of claim 17, wherein the predefined condition is satisfied if the confidence value drops below the running maximum minus an offset.

20. A non-transitory computer-readable storage medium having embodied thereon instructions, which when executed by at least one processor, perform steps of a method, the method comprising:
receiving an acoustic signal that includes a keyword portion immediately followed by a query portion, the acoustic signal representing at least one captured sound;
determining the end of the keyword portion;
based on the end of the keyword portion, separating the query portion from the keyword portion of the acoustic signal; and
providing the query portion, absent any part of the keyword portion, to an automatic speech recognition (ASR) system.
